(19) United States
(12) Patent Application Publication
(10) Pub. No.: US 2018/0342160 A1
(43) Pub. Date: Nov. 29, 2018

(54) OVERHEAD STRUCTURE DETERMINATION DEVICE AND DRIVING ASSISTANCE SYSTEM

(71) Applicant: TOYOTA JIDOSHA KABUSHIKI KAISHA, Toyota-shi (JP)

(72) Inventors: Terumoto KOMORI, Sizuoka-ken (JP); Nagisa KOYAMA, Nagakute-shi (JP)

(73) Assignee: TOYOTA JIDOSHA KABUSHIKI KAISHA, Toyota-shi (JP)

(21) Appl. No.: 15/964,963

(22) Filed: Apr. 27, 2018

(30) Foreign Application Priority Data
May 29, 2017 (JP) 2017-105750

(51) Int. Cl. G08G 1/16; G06K 9/00; G06K 9/62; G05D 1/02; B60T 7/22; B60T 8/171; B60T 8/172

(52) U.S. Cl. CPC G08G 1/166; G06K 9/00825; G06K 9/00798; G06K 9/6288; G05D 1/024; G05D 1/0246; H04L 67/12; B60T 7/22; B60T 8/171; B60T 8/172; G05D 1/027; G05D 1/0274; G08G 1/165; G05D 1/0257

(57) ABSTRACT

An overhead structure determination device mounted in a vehicle includes a sensor, a target information acquisition device, a road surface height acquisition device, and a determination device. The target information acquisition device detects a target in front of the vehicle using the sensor and acquires a relative position and a relative height of the target with respect to the vehicle. The road surface height acquisition device acquires a relative height of a below-target road surface with respect to the vehicle as a road surface height. The below-target road surface is a road surface at the relative position of the target. When a difference between the relative height of the target and the road surface height exceeds a threshold, the determination device determines that the target is an overhead structure present above a height of the vehicle.

### INCORPORATION BY REFERENCE

The disclosure of Japanese Patent Application No. 2017-105750 filed on May 29, 2017 including the specification, drawings and abstract is incorporated herein by reference in its entirety.

### BACKGROUND

### 1. Technical Field

The present disclosure relates to an overhead structure determination device and a driving assistance system mounted in a vehicle.

### 2. Description of Related Art

A driving assistance system mounted in a vehicle performs a driving assistance control for assisting in vehicle driving. A following traveling control or a collision avoidance control is known as the driving assistance control assisting in vehicle driving.

The following traveling control is a control for following a preceding vehicle while maintaining a set inter-vehicle distance. When the inter-vehicle distance to the preceding vehicle is less than the set value, the driving assistance system automatically operates a braking device to decelerate the vehicle.

The collision avoidance control is a control for avoiding collision with obstacles (other vehicles, bicycles, pedestrians, and the like) along the route. When a determination is made that there is a possibility of collision with an obstacle, the driving assistance system automatically operates the braking device to decelerate the vehicle.

For either of the following traveling control or the collision avoidance control, the obstacle or the preceding vehicle in front of the vehicle needs to be accurately recognized as “target object” using a vehicle-mounted sensor. The vehicle-mounted sensor not only detects the obstacle or the preceding vehicle present on the road surface but also detects “overhead structure” such as a sign, a signboard, an elevated object, or an overbridge disposed above the road surface. When an erroneous determination is made that such an overhead structure is an obstacle or a preceding vehicle, there is a possibility of unneeded deceleration of the vehicle. Unneeded deceleration (erroneous deceleration) of the vehicle makes a driver feel uncomfortable or anxious and decreases the reliability of the driving assistance system. Accordingly, the overhead structure needs to be accurately recognized when the driving assistance control is performed.

A vehicular obstacle recognition device is disclosed in Japanese Patent No. 3684776 (JP 3684776 B). The vehicular obstacle recognition device detects an obstacle present in front of a vehicle and detects the heightwise position of the obstacle using radar. When the detected heightwise position of the obstacle is present in a range not possible for a typical vehicle at least once, the vehicular obstacle recognition device determines that “the obstacle is not a vehicle”.

### SUMMARY

Accordingly, a determination as to whether or not a target in front of the vehicle is an overhead structure needs to be performed in the driving assistance control and the like. However, in the case of the technology disclosed in JP 3684776 B, merely the heightwise position of the obstacle with respect to the vehicle is considered, and there is a possibility of the following erroneous determinations. For example, when an uphill is present in front of the vehicle, an erroneous determination is made that a preceding vehicle that is traveling or is stopped on the uphill is “non-vehicle (not a vehicle)”. As another example, when a downhill is present in front of the vehicle, and an overhead structure that is disposed above the downhill is in a position facing the vehicle, an erroneous determination is made that the overhead structure is “vehicle (not an overhead structure)”.

The present disclosure provides a technology capable of highly accurately determining whether or not a target in front of a vehicle is an overhead structure.

A first aspect of the present disclosure relates to an overhead structure determination device mounted in a vehicle. The overhead structure determination device includes a sensor, a target information acquisition device configured to detect a target in front of the vehicle using the sensor and acquire a relative position and a relative height of the target with respect to the vehicle, a road surface height acquisition device configured to acquire a relative height of a below-target road surface with respect to the vehicle as a road surface height, the below-target road surface being a road surface at the relative position of the target, and a determination device configured to determine that the target is an overhead structure present above a height of the vehicle when a difference between the relative height of the target and the road surface height exceeds a threshold.

In the overhead structure determination device according to the first aspect of the present disclosure, the road surface height acquisition device may be configured to acquire the road surface height based on three-dimensional map information, position and azimuth information of the vehicle, and the relative position of the target.

In the overhead structure determination device according to the first aspect of the present disclosure, the sensor may be configured to detect an environment around the vehicle. The road surface height acquisition device may include a road surface estimation unit configured to detect a plurality of road surface points in front of the vehicle based on a detection result of the sensor and estimate a road surface in front of the vehicle from the road surface points, and a road surface height calculation unit configured to calculate the road surface height from the relative position of the target and the estimated road surface.

In the overhead structure determination device according to the first aspect of the present disclosure, the road surface estimation unit may be configured to directly specify the road surface points from the detection result of the sensor.

In the overhead structure determination device according to the first aspect of the present disclosure, the sensor may include a multi-lens camera and may be configured to extract the road surface point based on an imaging result of the multi-lens camera.

In the overhead structure determination device according to the first aspect of the present disclosure, the sensor may include LIDAR and may be configured to extract a characteristic portion having high reflectance for a laser beam radiated from the LIDAR as the road surface point.

In the overhead structure determination device according to the first aspect of the present disclosure, the sensor may include a radar and may be configured to extract a characteristic portion having high reflectance for an electromagnetic wave radiated from the radar as the road surface point.

In the overhead structure determination device according to the first aspect of the present disclosure, the road surface estimation unit may be configured to detect a plurality of specific structures having a known height from the road surface based on the detection result of the sensor. The road surface estimation unit may be configured to estimate the road surface points based on a relative position and a relative height of each of the specific structures with respect to the vehicle.

In the overhead structure determination device according to the first aspect of the present disclosure, the specific structure may be a delineator or a guardrail.

In the overhead structure determination device according to the first aspect of the present disclosure, the road surface estimation unit may be configured to detect a roadside structure disposed on a roadside based on the detection result of the sensor. The road surface estimation unit may be configured to estimate a plurality of sensor detection points corresponding to a lower end of the roadside structure as the road surface points.

In the overhead structure determination device according to the first aspect of the present disclosure, the road surface estimation unit may be configured to detect a plurality of moving targets in front of the vehicle based on the detection result of the sensor. The road surface estimation unit may be configured to estimate the road surface points based on a relative position and a relative height of each of the moving targets with respect to the vehicle.

In the overhead structure determination device according to the first aspect of the present disclosure, the road surface height acquisition device may further include an estimated road surface storage unit that stores shape information of the estimated road surface in association with position and azimuth information. The road surface height calculation unit may be configured to read the shape information of the estimated road surface from the estimated road surface storage unit and use the shape information of the estimated road surface when the vehicle travels on the same road as a road on which the vehicle has traveled in the past.

In the overhead structure determination device according to the first aspect of the present disclosure, the target information acquisition device, the road surface height acquisition device, and the determination device may be implemented by an electronic control unit.

A second aspect of the present disclosure relates to a driving assistance system mounted in a vehicle. The driving assistance system includes the overhead structure determination device according to the first aspect of the present disclosure, and a driving assistance control device that performs a driving assistance control. The driving assistance control includes at least one of a collision avoidance control for performing a control to avoid collision with a target object in front of the vehicle, or a following traveling control for performing a control to follow the target object while maintaining a set inter-vehicle distance. The driving assistance control device excludes the overhead structure from the target object in the driving assistance control.

In the driving assistance system according to the second aspect of the present disclosure, each of the target information acquisition device and the driving assistance control device may be implemented by an electronic control unit.

According to the first aspect of the present disclosure, not only the relative height of the target but also the road surface height of the below-target road surface immediately below the target is considered in the overhead structure determination. Performing the overhead structure determination by considering the road surface height as well suppresses erroneous determinations as in the case of the technology disclosed in JP 3684776 B. For example, when an uphill is present in front of the vehicle, a correct determination is made that a preceding vehicle that is traveling or is stopped on the uphill is “not the overhead structure”. As another example, when a downhill is present in front of the vehicle, and an overhead structure that is disposed above the downhill is in a position facing the vehicle, a correct determination is made that the overhead structure is “overhead structure”. That is, according to the present disclosure, it is possible to highly accurately determine whether or not the target in front of the vehicle is the overhead structure.

According to the first aspect of the present disclosure, the road surface height of the below-target road surface can be highly accurately acquired using the three-dimensional map information.

According to the first aspect of the present disclosure, the road surface points in front of the vehicle are detected based on the detection result of the sensor, and the road surface in front of the vehicle is estimated from the road surface points. The road surface height of the below-target road surface can also be acquired using the estimated road surface.

According to the first aspect of the present disclosure, the shape information of the estimated road surface is stored in the estimated road surface storage unit in association with the position and azimuth information. Accordingly, when the vehicle travels on the same road as the road on which the vehicle has traveled in the past, the shape information of the estimated road surface can be read from the estimated road surface storage unit and used. Since a road surface estimation process is not performed, a calculation load and a calculation time period needed for acquiring the road surface height are further reduced.

The driving assistance system according to the second aspect of the present disclosure uses the high-accuracy determination result of the overhead structure determination device according to the first aspect of the present disclosure. More specifically, when the overhead structure determination device determines that the target ahead is the overhead structure, the driving assistance control device excludes the target ahead (overhead structure) from the target object in the driving assistance control. According to the second aspect of the present disclosure, the overhead structure is determined with high accuracy, and erroneous determination is further suppressed. Thus, unneeded deceleration (erroneous deceleration) of the vehicle is further suppressed. Since unneeded deceleration of the vehicle is further suppressed, a situation where a driver feels uncomfortable and anxious is further reduced. Accordingly, the reliability of the driving assistance system is improved.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram illustrating an example of a vehicle and a target ahead according to an embodiment of the present disclosure;

FIG. 2 is a schematic diagram illustrating one example of a situation where an erroneous determination may be made in the related art;

FIG. 3 is a schematic diagram illustrating another example of the situation where an erroneous determination may be made in the related art;

FIG. 4 is a conceptual diagram for describing an overhead structure determination process according to the embodiment of the present disclosure;

FIG. 5 is a conceptual diagram for more specifically describing the overhead structure determination process according to the embodiment of the present disclosure;

FIG. 6 is a block diagram illustrating a configuration of an overhead structure determination device according to the embodiment of the present disclosure;

FIG. 7 is a flowchart schematically illustrating the overhead structure determination process of the overhead structure determination device according to the embodiment of the present disclosure;

FIG. 8 is a block diagram illustrating a first example of a road surface height acquisition device of the overhead structure determination device according to the embodiment of the present disclosure;

FIG. 9 is a block diagram illustrating a second example of the road surface height acquisition device of the overhead structure determination device according to the embodiment of the present disclosure;

FIG. 10 is a conceptual diagram for describing the second example of the road surface height acquisition device of the overhead structure determination device according to the embodiment of the present disclosure;

FIG. 11 is a conceptual diagram for describing a third example of the road surface height acquisition device of the overhead structure determination device according to the embodiment of the present disclosure;

FIG. 12 is a conceptual diagram for describing a fourth example of the road surface height acquisition device of the overhead structure determination device according to the embodiment of the present disclosure;

FIG. 13 is a conceptual diagram for describing a fifth example of the road surface height acquisition device of the overhead structure determination device according to the embodiment of the present disclosure;

FIG. 14 is a block diagram illustrating a sixth example of the road surface height acquisition device of the overhead structure determination device according to the embodiment of the present disclosure; and

FIG. 15 is a block diagram illustrating a configuration of a driving assistance system in which the overhead structure determination device according to the embodiment of the present disclosure is used.

### DETAILED DESCRIPTION OF EMBODIMENTS

An embodiment of the present disclosure will be described with reference to the appended drawings.

### 1. Summary

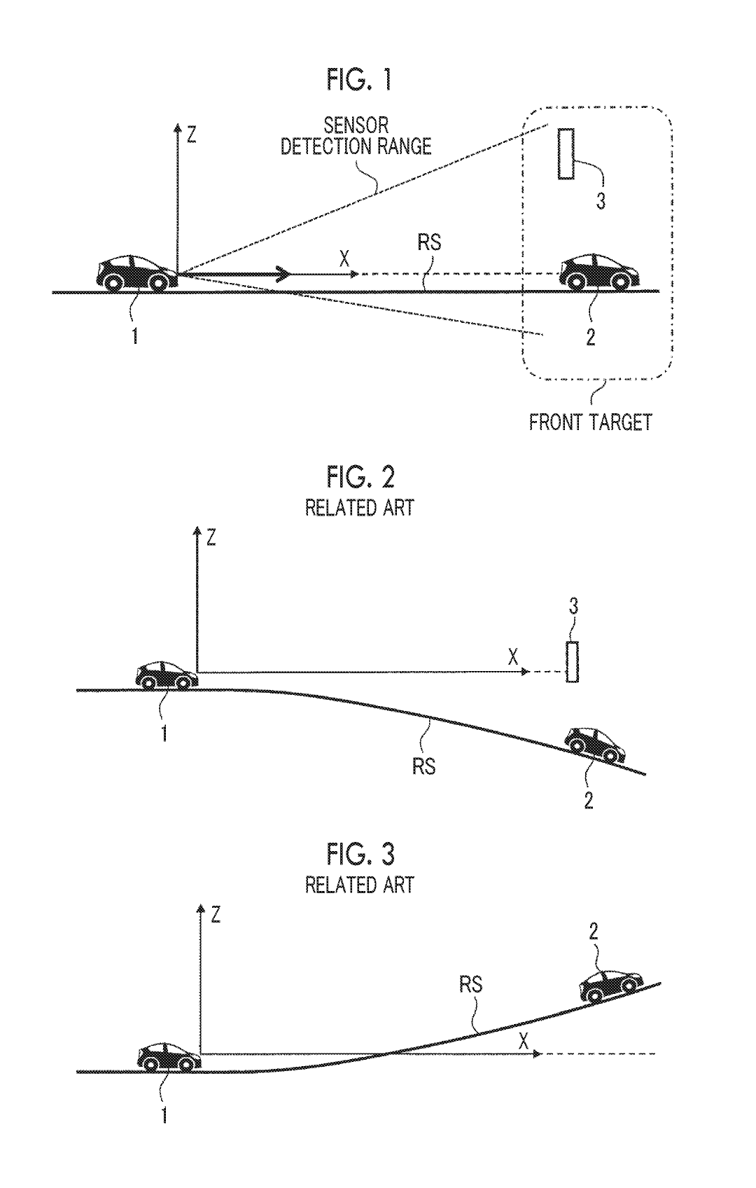

FIG. 1 is a schematic diagram illustrating an example of a vehicle 1 and a target ahead according to the present embodiment. The vehicle 1 is traveling in an X direction on a road surface RS. That is, the X direction represents the direction in which the vehicle 1 advances. A Z direction is orthogonal to the X direction and represents an upward direction, that is, a direction away from the road surface RS. A vehicle coordinate system that is fixed to the vehicle 1 is defined with the X direction and the Z direction.

The target ahead is present in front of the vehicle 1. In FIG. 1, a preceding vehicle 2 and an overhead structure 3 are illustrated as an example of the target ahead. The preceding vehicle 2 is traveling in the same lane as the vehicle 1 in front of the vehicle 1. The preceding vehicle 2 is present on the road surface RS. The overhead structure 3 is present away from the road surface RS in the Z direction. Particularly, the overhead structure 3 is present above the height of the vehicle 1. The overhead structure 3 is exemplified by a sign, a signboard, an elevated object, an overbridge, and the like.

The vehicle 1 can detect the target ahead using a sensor 40. The detected target ahead not only includes the preceding vehicle 2 but also includes the overhead structure 3 that has no possibility of colliding with the vehicle 1. Thus, identifying the overhead structure 3, that is, determining whether or not the detected target ahead is the overhead structure 3, is considered.

First, a determination method disclosed in JP 3684776 B is considered as a comparative example. According to the determination method of JP 3684776 B, the heightwise position of an obstacle with respect to a vehicle is detected using radar means for detecting the angle of a direction. When the detected heightwise position of the obstacle is present in a range not possible for a typical vehicle at least once, a determination is made that the obstacle is “not a vehicle”. However, such a determination method has a possibility of erroneous determination.

FIG. 2 illustrates one example of a situation where an erroneous determination may be made. In the example illustrated in FIG. 2, a downhill is present in front of the vehicle 1. The overhead structure 3 is disposed above the downhill. The overhead structure 3 is in a position directly facing (in the X direction) the vehicle 1 when seen from the current position of the vehicle 1. In such a situation, the determination method of JP 3684776 B erroneously determines that the overhead structure 3 in a position directly facing the vehicle 1 is “preceding vehicle 2 (not the overhead structure 3)”. When the vehicle 1 enters the downhill and approaches the overhead structure 3, the erroneous determination may be resolved. However, a delay in determination causes a delay in vehicle control and is not preferable.

FIG. 3 illustrates another example of the situation where an erroneous determination may be made. In the example illustrated in FIG. 3, an uphill is present in front of the vehicle 1. The preceding vehicle 2 is traveling or is stopped on the uphill. That is, the preceding vehicle 2 is in front of the vehicle 1 in an inclined direction when seen from the vehicle 1. In such a situation, the determination method of JP 3684776 B erroneously determines that the preceding vehicle 2 positioned in front of the vehicle 1 in an inclined direction is “non-vehicle (not a vehicle)”. Erroneously determining the preceding vehicle 2 as a non-vehicle is particularly not preferable from the viewpoint of safety.

The present embodiment provides a technology capable of suppressing erroneous determination as illustrated in FIG. 2 and FIG. 3, and accurately determining whether or not the target ahead is the overhead structure 3.

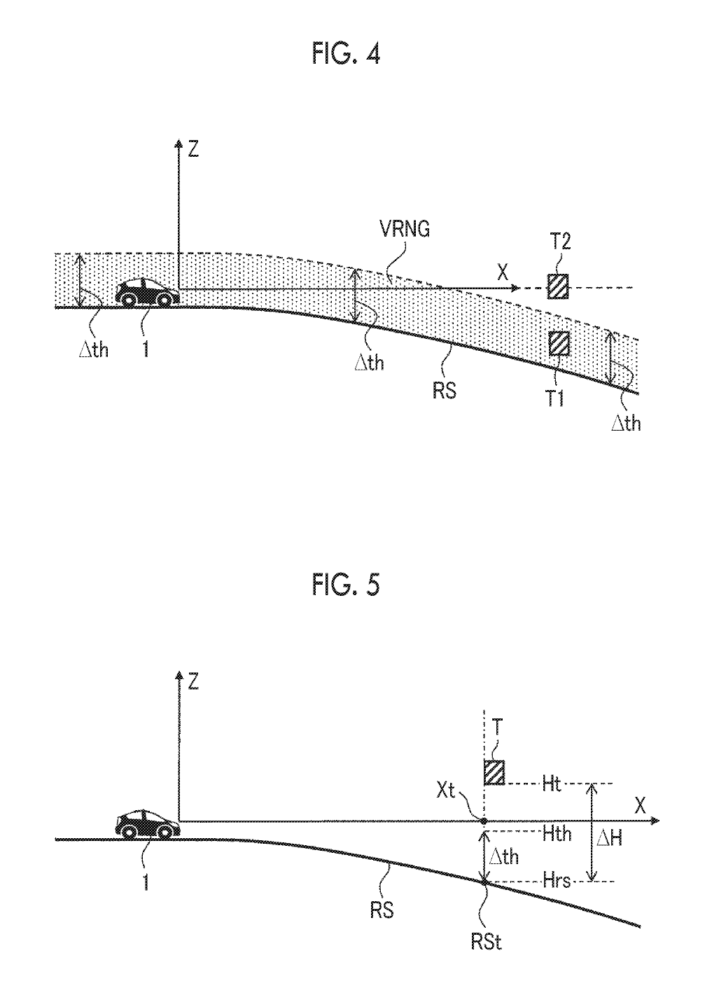

FIG. 4 is a conceptual diagram for describing an overhead structure determination process according to the present embodiment. In the present embodiment, a range in which a group of vehicles may be present from the road surface RS as a reference is considered. Hereinafter, the range in which a group of vehicles may be present will be referred to as “vehicle range VRNG”. As illustrated in FIG. 4, the vehicle range VRNG is defined as a range of a constant height Δth from the road surface RS. For example, the constant height Δth is the minimum ground clearance of the overhead structure 3 determined by law.

According to the present embodiment, when the target ahead detected by the sensor 40 is present in the vehicle range VRNG, a determination is made that the target ahead is not the overhead structure 3. When the detected target ahead is present outside the vehicle range VRNG, a determination is made that the target ahead is the overhead structure 3. In the example illustrated in FIG. 4, a determination is made that a target T1 in front of the vehicle 1 is not the overhead structure 3, and a determination is made that a target T2 is the overhead structure 3.

FIG. 5 is a conceptual diagram for more specifically describing the overhead structure determination process according to the present embodiment. In the following description, “relative position” with respect to the vehicle 1 means an X-direction position seen from the vehicle 1, that is, an X-direction position in the vehicle coordinate system fixed to the vehicle 1. In the following description, “relative height” with respect to the vehicle 1 means a Z-direction position seen from the vehicle 1, that is, a Z-direction position in the vehicle coordinate system fixed to the vehicle 1.

In FIG. 5, a target T is present in front of the vehicle 1. The relative position and the relative height of the target T with respect to the vehicle 1 are “target position Xt” and “target height Ht”, respectively. The road surface RS at the target position Xt of the target T, that is, the road surface RS immediately below the target T, is “below-target road surface RSt”. The relative height of the below-target road surface RSt with respect to the vehicle 1 is “road surface height Hrs”. The relative height of the upper limit of the vehicle range VRNG at the target position Xt is “vehicle range upper limit height Hth”. The vehicle range upper limit height Hth is provided as the sum of the road surface height Hrs and the constant height Δth (Hth=Hrs+Δth). Hereinafter, the constant height Δth will be referred to as “threshold Δth”.

A determination that the target T is not the overhead structure 3 is made when Relational Expression (1) or (2) below is established. Relational Expressions (1) and (2) are equivalent to each other.

Ht≤Hth (1)

ΔH=Ht−Hrs≤Δth (2)

Relational Expression (1) means that the target height Ht is less than or equal to the vehicle range upper limit height Hth, that is, the target T is present in the vehicle range VRNG. Relational Expression (2) means that a difference ΔH between the target height Ht and the road surface height Hrs is less than or equal to the threshold Δth.

A determination that the target T is the overhead structure 3 is made when Relational Expression (3) or (4) below is established. Relational Expressions (3) and (4) are equivalent to each other.

Ht>Hth (3)

ΔH=Ht−Hrs>Δth (4)

Relational Expression (3) means that the target height Ht is greater than the vehicle range upper limit height Hth, that is, the target T is present outside the vehicle range VRNG.

Relational Expression (4) means that the difference ΔH between the target height Ht and the road surface height Hrs exceeds the threshold Δth.

According to the present embodiment, not only the target height Ht of the target T but also the road surface height Hrs of the below-target road surface RSt immediately below the target T is considered in the overhead structure determination. Performing the overhead structure determination by considering the road surface height Hrs as well suppresses at least the erroneous determinations illustrated in FIG. 2 and FIG. 3. Specifically, in the situation illustrated in FIG. 2, a correct determination is made that the overhead structure 3 that is in a position directly facing the vehicle 1 is “overhead structure 3”. In the situation illustrated in FIG. 3, a correct determination is made that the preceding vehicle 2 that is positioned in front of the vehicle 1 in an inclined direction is “not the overhead structure 3”. That is, according to the present embodiment, it is possible to highly accurately determine whether or not the target in front of the vehicle 1 is the overhead structure 3.

Hereinafter, a configuration for implementing the overhead structure determination process according to the present embodiment will be described.

### 2. Overhead Structure Determination Device

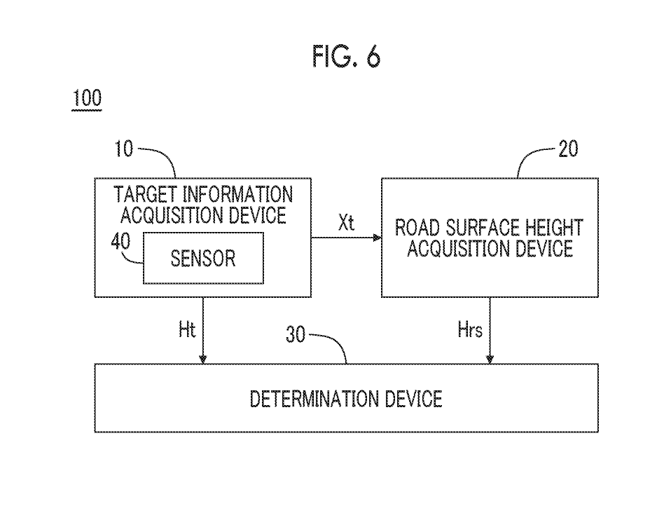

FIG. 6 is a block diagram illustrating a configuration of an overhead structure determination device 100 according to the present embodiment. The overhead structure determination device 100 is mounted in the vehicle 1 and determines whether or not the target ahead present in front of the vehicle 1 is the overhead structure 3. Specifically, the overhead structure determination device 100 includes a target information acquisition device 10, a road surface height acquisition device 20, and a determination device 30.

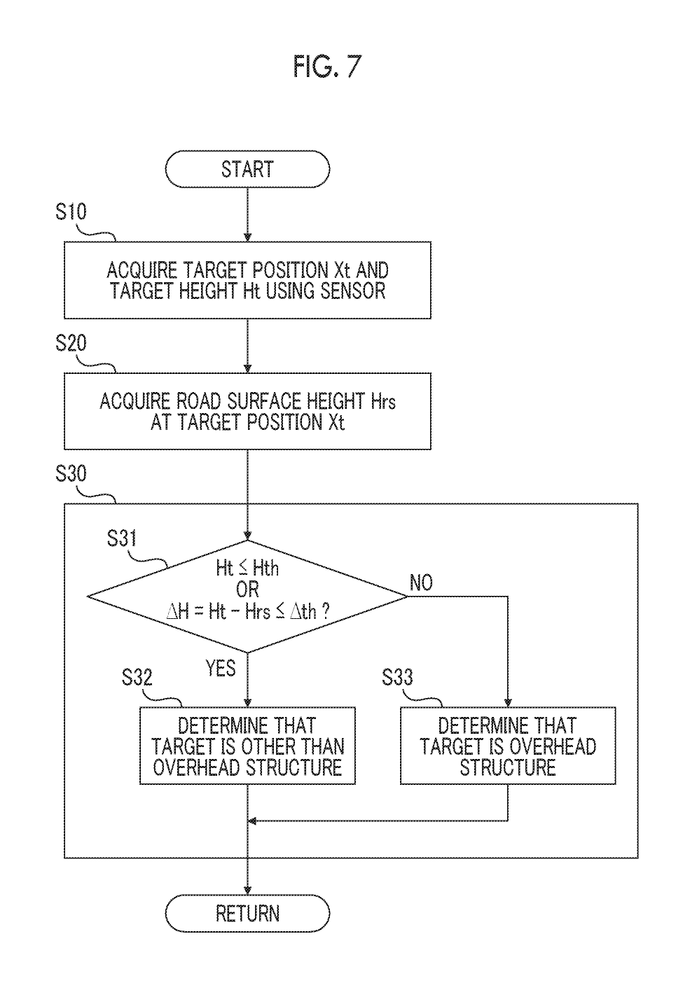

FIG. 7 is a flowchart schematically illustrating the overhead structure determination process of the overhead structure determination device 100 according to the present embodiment. Hereinafter, each of the target information acquisition device 10, the road surface height acquisition device 20, and the determination device 30 will be described with reference to FIG. 6 and FIG. 7.

### 2-1. Target Information Acquisition Device 10

The target information acquisition device 10 performs a target information acquisition process (step S10). Specifically, the target information acquisition device 10 detects the target T in front of the vehicle 1 and acquires the target position Xt and the target height Ht of the detected target T. The target information acquisition device 10 uses the sensor 40 for performing the target information acquisition process.

The sensor 40 is mounted in the vehicle 1 and detects the environment around the vehicle 1. The sensor 40 is exemplified by Laser Imaging Detection and Ranging (LIDAR), a millimeter wave radar, a camera, a sonar, an infrared sensor, and the like. A set of a plurality of the examples may be used as the sensor 40.

The target information acquisition device 10 detects the target T using the sensor 40 and acquires the target position Xt and the target height Ht of the detected target T. The method of detecting the target T and calculating the target position Xt and the target height Ht based on the detection result of the sensor 40 is well-known. Thus, the method of calculating the target position Xt and the target height Ht will not be specifically described. When a plurality of targets T is detected, the target information acquisition device 10 acquires the target position Xt and the target height Ht for each target T.

The relative height of a representative point of the target T is used as the target height Ht. For example, the representative point of the target T is the lower end of the target T. Alternatively, the upper end, the center, a feature point, or the like of the target T may be used as the representative point of the target T.

The target information acquisition device 10 outputs information indicating the target position Xt of each target T to the road surface height acquisition device 20. The target information acquisition device 10 outputs information indicating the target height Ht of each target T to the determination device 30.

### 2-2. Road Surface Height Acquisition Device 20

The road surface height acquisition device 20 performs a road surface height acquisition process (step S20). Specifically, the road surface height acquisition device 20 receives the information indicating the target position Xt of the target T from the target information acquisition device 10. The road surface height acquisition device 20 acquires the road surface height Hrs of the below-target road surface RSt that is the road surface RS at the target position Xt. Various examples of a method for acquiring the road surface height Hrs are considered. Various examples of a method for acquiring the road surface height Hrs will be specifically described below.

The road surface height acquisition device 20 outputs information indicating the road surface height Hrs of the below-target road surface RSt to the determination device 30.

### 2-3. Determination Device 30

The determination device 30 performs a determination process of determining whether or not the target T detected by the target information acquisition device 10 is the overhead structure 3 (step S30). When the targets T are detected, the determination process is performed for each target T.

More specifically, the determination device 30 receives the information indicating the target height Ht of the target T from the target information acquisition device 10. The determination device 30 receives the information indicating the road surface height Hrs of the below-target road surface RSt from the road surface height acquisition device 20. Furthermore, the determination device 30 acquires information that indicates the threshold Δth. The threshold Δth is a predetermined value (for example, the minimum ground clearance of the overhead structure 3 determined by law) and is stored in advance in a storage device. The determination device 30 reads the threshold Δth from the storage device.

The determination device 30 can determine whether or not the target T is the overhead structure 3 based on the target height Ht, the road surface height Hrs, the threshold Δth, and Relational Expressions (1) to (4). For example, the determination device 30 determines whether or not Relational Expression (1) or (2) is established (step S31). When Relational Expression (1) or (2) is established (step S31: YES), the determination device 30 determines that the target T is not the overhead structure 3 (step S32). In a case other than when Relational Expression (1) or (2) is established, that is, when Relational Expression (3) or (4) is established (step S31: NO), the determination device 30 determines that the target T is the overhead structure 3 (step S33).

The determination device 30 may count the number of times that Relational Expression (3) or (4) is established during a certain period. When the number of times that Relational Expression (3) or (4) is established reaches a predetermined threshold, the determination device 30 may determine that the target T is the overhead structure 3 (step S33).

The value of the target height Ht or the road surface height Hrs in the determination process may be a value acquired per cycle or may be a smoothed value acquired by a smoothing process. When the smoothed value is used, for example, the average value or the median value of a time-series value acquired through a plurality of cycles is calculated. Alternatively, the smoothed value may be calculated by applying a low-pass filter or a Kalman filter to the time-series value. Robust estimation such as RANSAC and M-estimation may be used. Performing the determination process using the smoothed value can further reduce the influence of shaking or vibration of the vehicle body on the determination result.

### 2-4. ECU

Data processing in the overhead structure determination device 100 is implemented by an electronic control unit (ECU). The ECU is a microcomputer that includes a processor, a storage device, and input and output interfaces. Various types of data processing are implemented by the processor executing a program stored in the storage device.

The target information acquisition device 10, the road surface height acquisition device 20, and the determination device 30 may individually include the ECU or may share one ECU. Configurations of the target information acquisition device 10, the road surface height acquisition device 20, and the determination device 30 may have common parts.

### 3. Various Examples of Road Surface Height Acquisition Device 20

Hereinafter, various examples of the road surface height acquisition device 20 according to the present embodiment will be described.

### 3-1. First Example

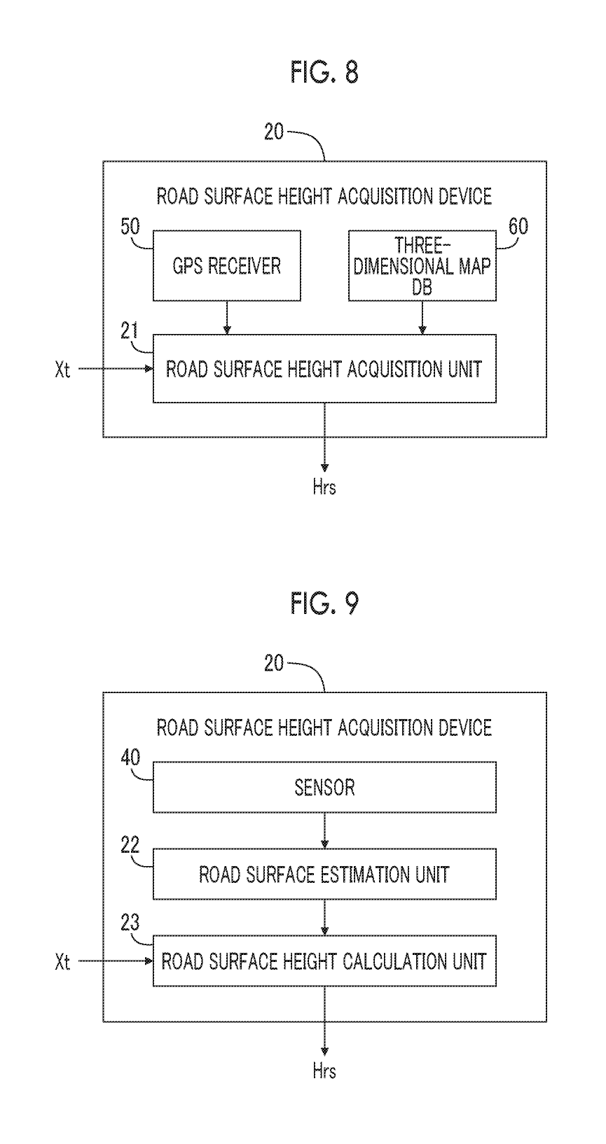

FIG. 8 is a block diagram illustrating a first example of the road surface height acquisition device 20 according to the present embodiment. In the first example, the road surface height acquisition device 20 includes a GPS receiver 50, a three-dimensional map database 60, and a road surface height acquisition unit 21.

The GPS receiver 50 receives signals transmitted from a plurality of GPS satellites and calculates the position and the azimuth of the vehicle 1 based on the received signals. The GPS receiver 50 transfers position and azimuth information indicating the calculated position and the azimuth to the road surface height acquisition unit 21.

The three-dimensional map database 60 is a database of three-dimensional map information that indicates the three-dimensional position of roads. For example, the three-dimensional position is configured with the latitude, the longitude, and the relative height with respect to a reference point. The three-dimensional map database 60 is stored in a predetermined storage device.

The road surface height acquisition unit 21 receives the position and azimuth information from the GPS receiver 50. The road surface height acquisition unit 21 acquires the three-dimensional map information around the current position of the vehicle 1 from the three-dimensional map database 60. The road surface height acquisition unit 21 receives the information indicating the target position Xt of the target T from the target information acquisition device 10. The road surface height acquisition unit 21 acquires the road surface height Hrs of the below-target road surface RSt from the position and azimuth information of the vehicle 1, the target position Xt (the relative position of the target T), and the three-dimensional map information. The road surface height acquisition unit 21 is implemented by the ECU.

According to the first example, the road surface height Hrs of the below-target road surface RSt can be highly accurately acquired using the three-dimensional map information.

### 3-2. Second Example

FIG. 9 is a block diagram illustrating a second example of the road surface height acquisition device 20 according to the present embodiment. In the second example, the road surface height acquisition device 20 includes the sensor 40, a road surface estimation unit 22, and a road surface height calculation unit 23.

As described above, the sensor 40 detects the environment around the vehicle 1. The sensor 40 is exemplified by LIDAR, a radar, a camera, a sonar, an infrared sensor, and the like. The road surface estimation unit 22 estimates the road surface RS in front of the vehicle 1 based on the detection result of the sensor 40.

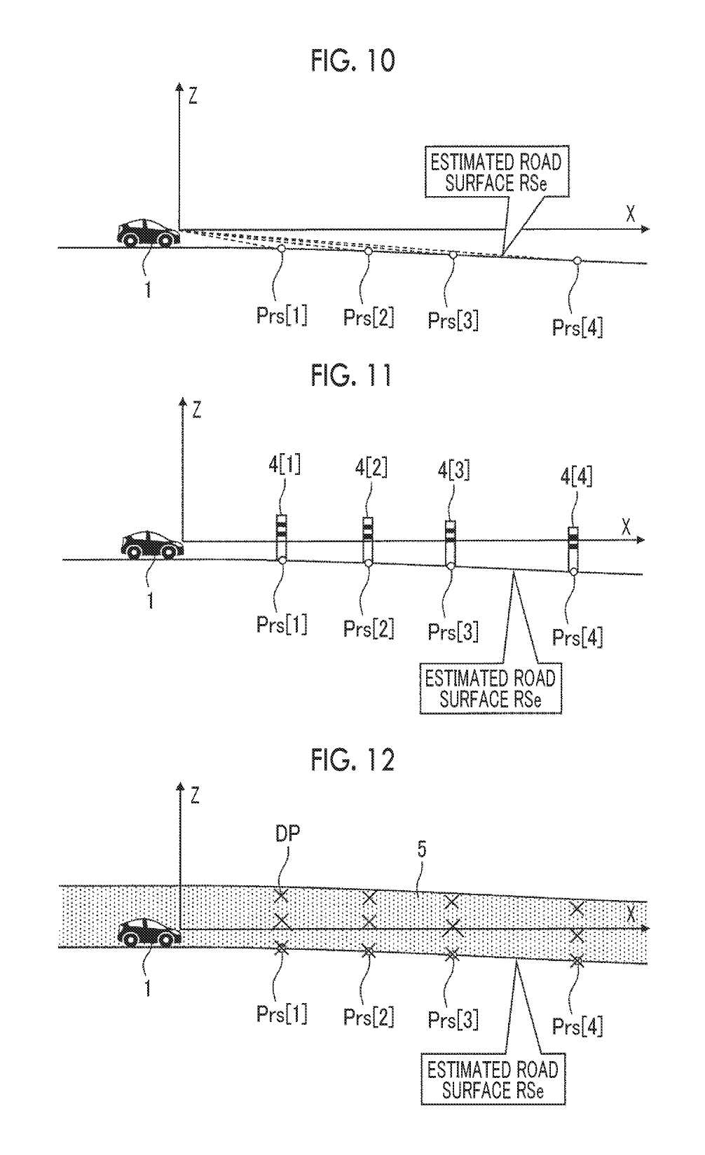

FIG. 10 is a conceptual diagram for describing a road surface estimation method in the second example. The road surface estimation unit 22 detects a plurality of road surface points Prs present in front of the vehicle 1 based on the detection result of the sensor 40. Each road surface point Prs is a point that represents the road surface RS at a certain position. In FIG. 10, four road surface points Prs[1] to Prs[4] at four positions are illustrated. The number of detected road surface points Prs is not limited to four.

For example, a case where the sensor 40 includes a multi-lens camera (stereo camera) is considered. The multi-lens camera images the road surface RS in front of the vehicle 1. The road surface estimation unit 22 can extract a characteristic portion on the road surface RS as the road surface point Prs from the imaging result of the multi-lens camera. The characteristic portion in such a case is exemplified by portions having a white line, a mark, a minute roughness, a texture (shape), and the like.

A case where the sensor 40 includes LIDAR is considered as another example. A laser beam radiated from the LIDAR is relatively strongly reflected in the characteristic portion such as a white line and a mark on the road surface RS. The characteristic portion that has relatively high reflectance can be used as the road surface point Prs. That is, the road surface estimation unit 22 can extract the characteristic portion having relatively high reflectance for the laser beam as the road surface point Prs from the detection result of the LIDAR.

The same applies to a case where the sensor 40 includes a radar. An electromagnetic wave radiated from the radar is relatively strongly reflected in the characteristic portion on the road surface RS. The road surface estimation unit 22 can extract the characteristic portion having relatively high reflectance for the electromagnetic wave as the road surface point Prs from the detection result of the radar.

Accordingly, the road surface estimation unit 22 can directly specify the road surface points Prs from the detection result of the sensor 40. The road surface estimation unit 22 can detect the relative position and the relative height of each road surface point Prs from the detection result of the sensor 40. Accordingly, the road surface estimation unit 22 can estimate the road surface RS in front of the vehicle 1 from the road surface points Prs. For example, the road surface RS can be estimated by fitting the road surface points Prs in a three-dimensional curved plane. Hereinafter, the road surface RS estimated by the road surface estimation unit 22 will be referred to as “estimated road surface RSe”.

With reference to FIG. 9 again, the road surface height calculation unit 23 receives information related to the shape (relative position and relative height) of the estimated road surface RSe from the road surface estimation unit 22. The road surface height calculation unit 23 receives the information indicating the target position Xt of the target T from the target information acquisition device 10. The road surface height calculation unit 23 calculates the road surface height Hrs of the below-target road surface RSt from the target position Xt (the relative position of the target T) and the estimated road surface RSe.

The road surface estimation unit 22 and the road surface height calculation unit 23 are implemented by the ECU. The configuration of the road surface height acquisition device 20 in the second example that uses the sensor 40 may have common parts with the target information acquisition device 10.

### 3-3. Third Example

A configuration of the road surface height acquisition device 20 in a third example is the same as that illustrated in FIG. 9. The difference between the third example and the second example is the method of determining the estimated road surface RSe in the road surface estimation unit 22.

FIG. 11 is a conceptual diagram for describing a road surface estimation method in the third example. In the example illustrated in FIG. 11, a plurality of specific structures 4 having a known height from the road surface RS is disposed on the road surface RS. The specific structures 4 are exemplified by delineators, guardrails, and the like.

The road surface estimation unit 22 detects and identifies the specific structures 4 based on the detection result of the sensor 40. The process of detecting the specific structures 4 is the same as the target detection process of the target information acquisition device 10. Accordingly, the target information acquisition device 10 and the road surface height acquisition device 20 may have common parts. The process of identifying the specific structures 4 is performed based on the shape, the positional relationship with the lane boundary, and the like.

The height of each specific structure 4 from the road surface RS is known. The road surface estimation unit 22 retains information related to the known height in advance. Accordingly, the road surface estimation unit 22 can estimate the road surface points Prs based on the known height and the detected information (relative position and relative height) of each of the specific structures 4. In the example illustrated in FIG. 11, the road surface estimation unit 22 detects the specific structures 4[1] to 4[4] and estimates the road surface points Prs[1] to Prs[4] based on the detected information of each of the specific structures 4[1] to 4[4].

Then, the same process as the second example is performed. The road surface estimation unit 22 determines the estimated road surface RSe from the road surface points Prs. The road surface height calculation unit 23 calculates the road surface height Hrs of the below-target road surface RSt from the target position Xt and the estimated road surface RSe.

### 3-4. Fourth Example

A configuration of the road surface height acquisition device 20 in a fourth example is the same as that illustrated in FIG. 9. The difference between the fourth example and the second example is the method of determining the estimated road surface RSe in the road surface estimation unit 22.

FIG. 12 is a conceptual diagram for describing a road surface estimation method in the fourth example. In the example illustrated in FIG. 12, a roadside structure 5 (side structure) is disposed on the roadside. The roadside structure 5 is exemplified by a noise barrier, a curb, and the like.

The road surface estimation unit 22 detects and identifies the roadside structure 5 based on the detection result of the sensor 40. The process of detecting the roadside structure 5 is the same as the target detection process of the target information acquisition device 10. Accordingly, the target information acquisition device 10 and the road surface height acquisition device 20 may have common parts. The process of identifying the roadside structure 5 is performed based on the shape, the positional relationship with the lane boundary, and the like.

As illustrated in FIG. 12, the roadside structure 5 is detected at multiple sensor detection points DP. Each sensor detection point DP is a point (distance measurement point) detected by the sensor 40. In the fourth example, the sensor detection point DP that is present at the lower end among the multiple sensor detection points DP representing the roadside structure 5 is used as the road surface point Prs representing the road surface RS. That is, the road surface estimation unit 22 estimates the sensor detection points DP corresponding to the lower end of the roadside structure 5 as the road surface points Prs[1] to Prs[4].

Then, the same process as the second example is performed. The road surface estimation unit 22 determines the estimated road surface RSe from the road surface points Prs. The road surface height calculation unit 23 calculates the road surface height Hrs of the below-target road surface RSt from the target position Xt and the estimated road surface RSe.

### 3-5. Fifth Example

A configuration of the road surface height acquisition device 20 in a fifth example is the same as that illustrated in FIG. 9. The difference between the fifth example and the second example is the method of determining the estimated road surface RSe in the road surface estimation unit 22.

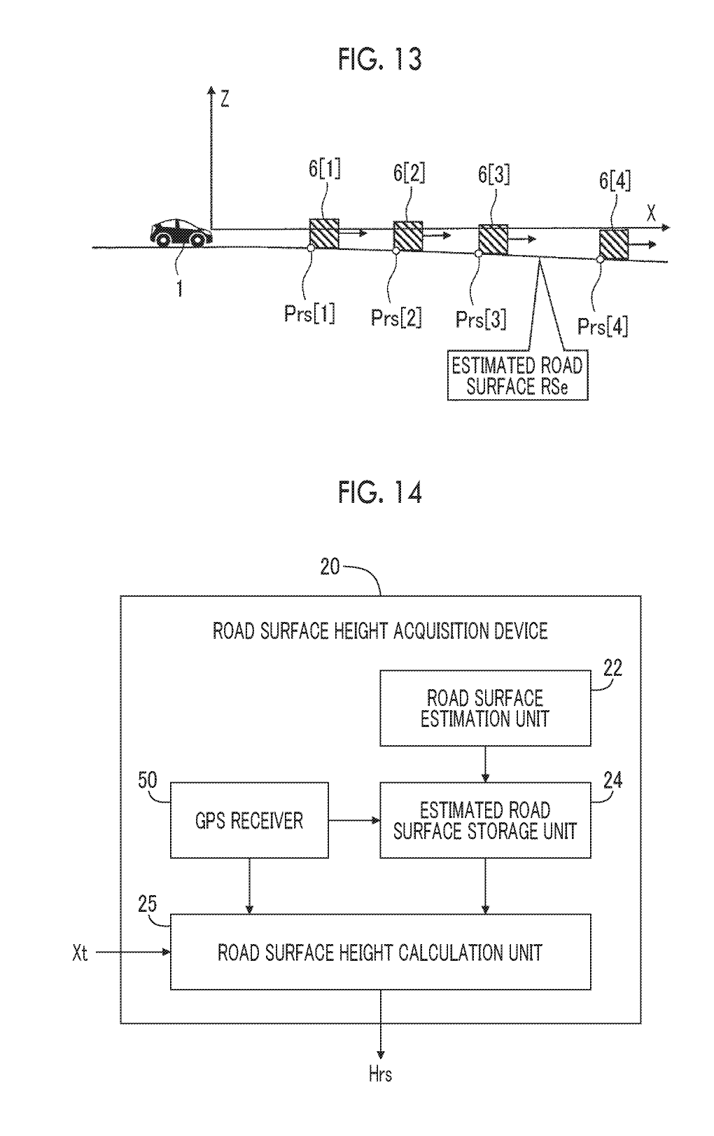

FIG. 13 is a conceptual diagram for describing a road surface estimation method in the fifth example. In the example illustrated in FIG. 13, a moving target 6 is present on the road surface RS in front of the vehicle 1. The moving target 6 is exemplified by a preceding vehicle.

The road surface estimation unit 22 detects a plurality of moving targets 6 in front of the vehicle 1 based on the detection result of the sensor 40. The process of detecting each moving target 6 is the same as the target detection process of the target information acquisition device 10. Accordingly, the target information acquisition device 10 and the road surface height acquisition device 20 may have common parts.

The road surface estimation unit 22 can estimate the road surface points Prs based on the detected information (relative position and relative height) of each of the moving targets 6. In the example illustrated in FIG. 13, the road surface estimation unit 22 detects the moving targets 6[1] to 6[4] and estimates the road surface points Prs[1] to Prs[4] based on the detected information of each of the moving targets 6[1] to 6[4].

Then, the same process as the second example is performed. The road surface estimation unit 22 determines the estimated road surface RSe from the road surface points Prs. The road surface height calculation unit 23 calculates the road surface height Hrs of the below-target road surface RSt from the target position Xt and the estimated road surface RSe.

### 3-6. Sixth Example

FIG. 14 is a block diagram illustrating a sixth example of the road surface height acquisition device 20 according to the present embodiment. In the sixth example, the road surface height acquisition device 20 includes the GPS receiver 50, the road surface estimation unit 22, an estimated road surface storage unit 24, and a road surface height calculation unit 25.

The GPS receiver 50 receives signals transmitted from the GPS satellites and calculates the position and the azimuth of the vehicle 1 based on the received signals. The GPS receiver 50 transfers the position and azimuth information indicating the calculated position and the azimuth to the estimated road surface storage unit 24 and the road surface height calculation unit 25.

The road surface estimation unit 22 is the same as the road surface estimation unit 22 described in any of the second example to the fifth example. The road surface estimation unit 22 determines the estimated road surface RSe using the road surface estimation method described in any of the second example to the fifth example.

The estimated road surface storage unit 24 receives the position and azimuth information from the GPS receiver 50 and receives shape information of the estimated road surface RSe from the road surface estimation unit 22. The estimated road surface storage unit 24 stores the shape information of the estimated road surface RSe in association with the position and azimuth information. The estimated road surface storage unit 24 is implemented by a predetermined storage device.

According to the sixth example, when the vehicle 1 travels on the same road as a road on which the vehicle 1 has traveled in the past, information of the estimated road surface RSe stored in the estimated road surface storage unit 24 is used. In other words, the road surface estimation process is not performed for the road on which the vehicle 1 has traveled in the past.

More specifically, the road surface height calculation unit 25 receives the position and azimuth information from the GPS receiver 50. The road surface height calculation unit 25 confirms whether or not the shape information related to the estimated road surface RSe around the current position of the vehicle 1 is stored in the estimated road surface storage unit 24. When the shape information of the estimated road surface RSe around the current position of the vehicle 1 is stored in the estimated road surface storage unit 24, the road surface height calculation unit 25 reads the shape information of the estimated road surface RSe from the estimated road surface storage unit 24.

The road surface height calculation unit 25 receives the information indicating the target position Xt of the target T from the target information acquisition device 10. The road surface height calculation unit 25 calculates the road surface height Hrs of the below-target road surface RSt from the target position Xt (the relative position of the target T) and the estimated road surface RSe. The road surface height calculation unit 25 is implemented by the ECU.

According to the sixth example, when the vehicle 1 travels on the road on which the vehicle 1 has traveled in the past, the road surface height calculation unit 25 reads the shape information of the estimated road surface RSe from the estimated road surface storage unit 24 and uses the shape information of the estimated road surface RSe. Since the road surface estimation unit 22 does not perform the road surface estimation process, a calculation load and a calculation time period needed for acquiring the road surface height Hrs are further reduced.

### 3-7. Seventh Example

A plurality of the first example to the sixth example may be appropriately combined.

For example, the road surface height acquisition device 20 acquires a plurality of types of road surface heights Hrs for one target T using the method according to each of the examples. The road surface height acquisition device 20 calculates one representative road surface height Hrs from the types of road surface heights Hrs. For example, the road surface height acquisition device 20 calculates the average value or the median value of the types of road surface heights Hrs as the representative road surface height Hrs.

As another example, the road surface height acquisition device 20 acquires a plurality of types of road surface shape information using the method according to each of the examples. The road surface shape information may be the shape information of the road surface RS that is directly acquired from the three-dimensional map database 60 in the first example, or may be the shape information of the estimated road surface RSe acquired in the second example to the sixth example. The road surface height acquisition device 20 calculates one representative type of road surface shape information from the types of road surface shape information. For example, the road surface height acquisition device 20 corrects (translates and rotates) certain road surface shape information to minimize the sum of errors with respect to the remaining types of road surface shape information. The road surface shape information acquired by such correction is used as the representative road surface shape information. The road surface height acquisition device 20 calculates the road surface height Hrs using the representative road surface shape information.

The influence of noise and the like is further reduced by unifying the types of road surface heights Hrs or the types of road surface shape information.

### 4. Driving Assistance System

Typically, the overhead structure determination device 100 is applied to a driving assistance system that assists in driving the vehicle 1. Hereinafter, a driving assistance system in which the overhead structure determination device 100 according to the present embodiment is used will be described.

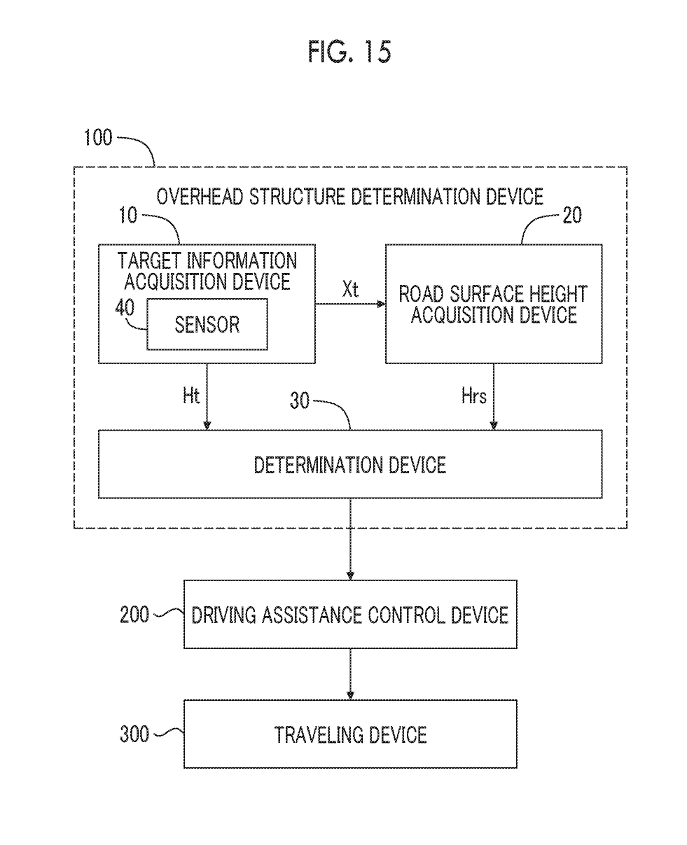

FIG. 15 is a block diagram illustrating a configuration of the driving assistance system in which the overhead structure determination device 100 according to the present embodiment is used. The driving assistance system is mounted in the vehicle 1 and includes the overhead structure determination device 100, a driving assistance control device 200, and a traveling device 300. The traveling device 300 includes a driving device that drives the vehicle 1, a braking device that applies brake force, and a steering device that steers the vehicle 1.

The driving assistance control device 200 performs a driving assistance control for assisting in driving the vehicle 1. The driving assistance control device 200 is implemented by the ECU. At least one of a following traveling control or a collision avoidance control is performed as the driving assistance control.

The following traveling control is a control for following the preceding vehicle 2 while maintaining a set inter-vehicle distance, and is referred to as an adaptive cruise control (ACC). When the inter-vehicle distance to the preceding vehicle 2 is less than the set value, the driving assistance control device 200 automatically operates the braking device of the traveling device 300 to decelerate the vehicle 1.

The collision avoidance control is a control for avoiding collision with obstacles (other vehicles, bicycles, pedestrians, and the like) along the route and is referred to as a pre-crash safety system (PCS). When a determination is made that there is a possibility of collision with an obstacle, the driving assistance control device 200 automatically operates the braking device of the traveling device 300 to decelerate the vehicle 1.

For either of the following traveling control or the collision avoidance control, the obstacle or the preceding vehicle in front of the vehicle needs to be accurately recognized as “target object” using the sensor 40. The sensor 40 not only detects the obstacle or the preceding vehicle 2 present on the road surface RS but also detects the overhead structure 3 present above the road surface RS. When an erroneous determination is made that the overhead structure 3 is the obstacle or the preceding vehicle 2, there is a possibility of unneeded deceleration of the vehicle. Unneeded deceleration (erroneous deceleration) of the vehicle makes a driver feel uncomfortable or anxious and decreases the reliability of the driving assistance system. Accordingly, the overhead structure 3 needs to be accurately recognized when the driving assistance control is performed.

Thus, the driving assistance control device 200 according to the present embodiment uses the determination result of the overhead structure determination device 100. More specifically, when the overhead structure determination device 100 determines that the target ahead is the overhead structure 3, the driving assistance control device 200 excludes the target ahead (overhead structure 3) from the target object in the driving assistance control.

As described above, the overhead structure determination device 100 according to the present embodiment can highly accurately determine that the target ahead is the overhead structure 3. Since an erroneous determination that the overhead structure 3 is the obstacle or the preceding vehicle 2 is further suppressed, unneeded deceleration (erroneous deceleration) of the vehicle is further suppressed. Since unneeded deceleration of the vehicle is further suppressed, a situation where the driver feels uncomfortable and anxious is further reduced. Accordingly, the reliability of the driving assistance system is improved.

According to the present embodiment, an erroneous determination that the preceding vehicle 2 positioned ahead in an inclined direction is the overhead structure 3 is not made in the situation illustrated in FIG. 3. When an erroneous determination that the stopped preceding vehicle 2 is the overhead structure 3 is made, the collision avoidance control is not normally operated, and a dangerous situation is caused. However, the problem that the collision avoidance control is not normally operated does not arise in the present embodiment. Accordingly, the reliability of the driving assistance system is improved.

What is claimed is:

1. An overhead structure determination device mounted in a vehicle, the overhead structure determination device comprising:
a sensor;
a target information acquisition device configured to detect a target in front of the vehicle using the sensor and acquire a relative position and a relative height of the target with respect to the vehicle;
a road surface height acquisition device configured to acquire a relative height of a below-target road surface with respect to the vehicle as a road surface height, the below-target road surface being a road surface at the relative position of the target; and
a determination device configured to determine that the target is an overhead structure present above a height of the vehicle when a difference between the relative height of the target and the road surface height exceeds a threshold.

2. The overhead structure determination device according to claim 1, wherein the road surface height acquisition device is configured to acquire the road surface height based on three-dimensional map information, position and azimuth information of the vehicle, and the relative position of the target.

3. The overhead structure determination device according to claim 1, wherein:
the sensor is configured to detect an environment around the vehicle; and
the road surface height acquisition device includes
a road surface estimation unit configured to detect a plurality of road surface points in front of the vehicle based on a detection result of the sensor and estimate a road surface in front of the vehicle from the road surface points, and
a road surface height calculation unit configured to calculate the road surface height from the relative position of the target and the estimated road surface.

4. The overhead structure determination device according to claim 3, wherein the road surface estimation unit is configured to directly specify the road surface points from the detection result of the sensor.

5. The overhead structure determination device according to claim 4, wherein the sensor includes a multi-lens camera and is configured to extract the road surface point based on an imaging result of the multi-lens camera.

6. The overhead structure determination device according to claim 4, wherein the sensor includes Laser Imaging Detection and Ranging and is configured to extract a characteristic portion having high reflectance for a laser beam radiated from the Laser Imaging Detection and Ranging as the road surface point.

7. The overhead structure determination device according to claim 4, wherein the sensor includes a radar and is configured to extract a characteristic portion having high reflectance for an electromagnetic wave radiated from the radar as the road surface point.

8. The overhead structure determination device according to claim 3, wherein the road surface estimation unit is configured to
detect a plurality of specific structures having a known height from the road surface based on the detection result of the sensor, and
estimate the road surface points based on a relative position and a relative height of each of the specific structures with respect to the vehicle.

9. The overhead structure determination device according to claim 8, wherein the specific structure is a delineator or a guardrail.

10. The overhead structure determination device according to claim 3, wherein the road surface estimation unit is configured to
detect a roadside structure disposed on a roadside based on the detection result of the sensor, and
estimate a plurality of sensor detection points corresponding to a lower end of the roadside structure as the road surface points.

11. The overhead structure determination device according to claim 3, wherein the road surface estimation unit is configured to
detect a plurality of moving targets in front of the vehicle based on the detection result of the sensor, and
estimate the road surface points based on a relative position and a relative height of each of the moving targets with respect to the vehicle.

12. The overhead structure determination device according to claim 3, wherein:
the road surface height acquisition device further includes an estimated road surface storage unit that stores shape information of the estimated road surface in association with position and azimuth information; and
the road surface height calculation unit is configured to read the shape information of the estimated road surface from the estimated road surface storage unit and use the shape information of the estimated road surface when the vehicle travels on the same road as a road on which the vehicle has traveled in the past.

13. The overhead structure determination device according to claim 1, wherein the target information acquisition device, the road surface height acquisition device, and the determination device are implemented by an electronic control unit.

14. A driving assistance system mounted in a vehicle, the driving assistance system comprising:
the overhead structure determination device according to claim 1; and
a driving assistance control device that performs a driving assistance control, wherein:
the driving assistance control includes at least one of a collision avoidance control for performing a control to avoid collision with a target object in front of the vehicle, or a following traveling control for performing a control to follow the target object while maintaining a set inter-vehicle distance; and
the driving assistance control device excludes the overhead structure from the target object in the driving assistance control.

15. The driving assistance system according to claim 14, wherein each of the target information acquisition device and the driving assistance control device is implemented by an electronic control unit.
